(19) United States
(12) Patent Application Publication
(10) Pub. No.: US 2001/0042762 A1
(43) Pub. Date: Nov. 22, 2001

(54) Cartridge

(76) Inventor: Lothar Reichert, Engelskirchen (DE)

Correspondence Address: Flynn, Thiel, Boutell & Tanis, P.C., 2026 Rambling Road, Kalamazoo, MI, 49008-1699, US

(21) Appl. No.: 09/851,913

(22) Filed: May 9, 2001

(30) Foreign Application Priority Data
May 11, 2000 (DE) 200 08 507.7

(51) Int. Cl. G01F 11/06; B65D 88/54

(52) U.S. Cl. 222/326; 222/95; 222/105; 222/391

(57) ABSTRACT

A cartridge for a cartridge gun in which the cartridge can be connected self-supportingly to the cartridge gun, and for receiving a bag filled with an injection material- The cartridge includes a housing member in which a piston is arranged longitudinally movably toward an and closed off by a lid. The lid has an opening through which ah injection nozzle is received. The housing member has on an end remote from the lid an area in form of an annular connecting piece for facilitating connection of the cartridge to a cartridge gun.

The invention relates to a cartridge for a cartridge gun, in which the cartridge can be connected self-supportingly to the cartridge gun, and for receiving a bag filled with an injection material, the cartridge having a housing member in which a piston is arranged longitudinally movably toward an end closed off by a lid. The lid has a recess or opening through which an injection nozzle is received.

### BACKGROUND OF THE INVENTION

Cartridges are known from the state of the art. A bag filled with an injection material is placed into such a cartridge. The advantageously tubular bag is thereby inserted between the injection nozzle and a piston in the cartridge. When the piston is when moved in direction of the injection nozzle, the piston presses onto the bag and the injection material is pressed out of a bag opening on the injection nozzle side through the injection nozzle and thence out of the cartridge.

Such a cartridge can be inserted into a commercially available cartridge gun having a cartridge holding structure. The cartridge holding structure consists primarily of a trough or cup, the shape of which is conformed to the outer shape of the cartridge. The proximal end of the trough is fastened to a handle on the cartridge gun. This proximal end and handle has a recess into which a pressure rod with a piston thereon can be moved. The opposite end of the trough or cup is slotted so that the injection nozzle of the cartridge can be placed into this slot. A disadvantage of this combination compared with commercially available cartridge gland and the mentioned cartridges is that the housing of the cartridge Nat be conformed to the trough or cup of the cartridge holding structure on the cartridge gun.

Furthermore a cartridge gun is known from DE 299 04 071.2 (corresponding to U.S. pending application Ser. No. 09/595 291 filed on Jun. 15, 2000), in which the cartridge holding structure has merely a receiving means into which is inserted the end of a commercially available cartridge and is self-supportingly held by means of resilient claws. The disadvantage of the known cartridges for receiving a bag filled with an injection material is that such cartridges could not be inserted into this novel cartridge gun known from the aforesaid DE 299 04 071.2.

### SUMMARY OF THE INVENTION

The basic purpose of the invention is to provide a cartridge for receiving bags filled with an injection material, which cartridge can be inserted into a cartridge gun, as it is, for example, known from the aforesaid DE 299 04 071.2

This purpose is attained according to the invention by providing a cartridge having an elongate housing, a proximal end remote from a lid having an area in the form of an annular connecting piece for facilitating a connecting of the cartridge housing to the cartridge gun.

The proximal end of the cartridge housing opposite the injection nozzle has thus an annular connecting piece which is formed like the corresponding end of a cartridge in order to be insertable into the cartridge gun known from the aforesaid DE 299 04 071.2. Since only the connecting piece must be conformed to the cartridge gun and the cartridge housing is self-supportingly fastened in the cartridge holding structure, the cartridge housing itself may have any desired diameter or any desired cross-sectional shape. Thus it is possible, for example, to connect also cartridge housings with greater volumes for larger injection-material begs to this cartridge gun.

The connecting piece can according to the invention have an outside diameter which is the same or insignificantly smaller than the inside diameter of an annular receiving part on the cartridge gun. Furthermore according to the invention the connecting piece can have an inside diameter which is the same or insignificantly larger than the outside diameter of a raised connecting surface of the cartridge gun.

The lid of the cartridge housing can according to the invention be fastened to the cartridge housing by means of a thread in the form of a screw cap. It is thereby, among others, also possible that the lid be alternately mounted on the cartridge horsing by means of a bayonet catch.

### BRIEF DESCRIPTION OF THE DRAWINGS

One exemplary embodiment is described in greater detail in connection with the drawings, in which;

FIG. 1 shows a cartridge housing of the invention with an inserted bag, and

FIG. 2 shows a cartridge housing of the invention which is connected to a cartridge gun.

### DETAILED DESCRIPTION

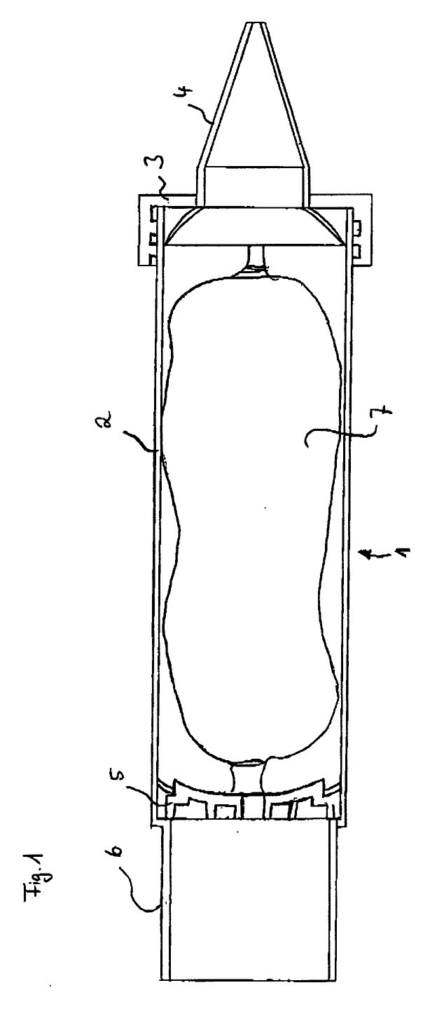

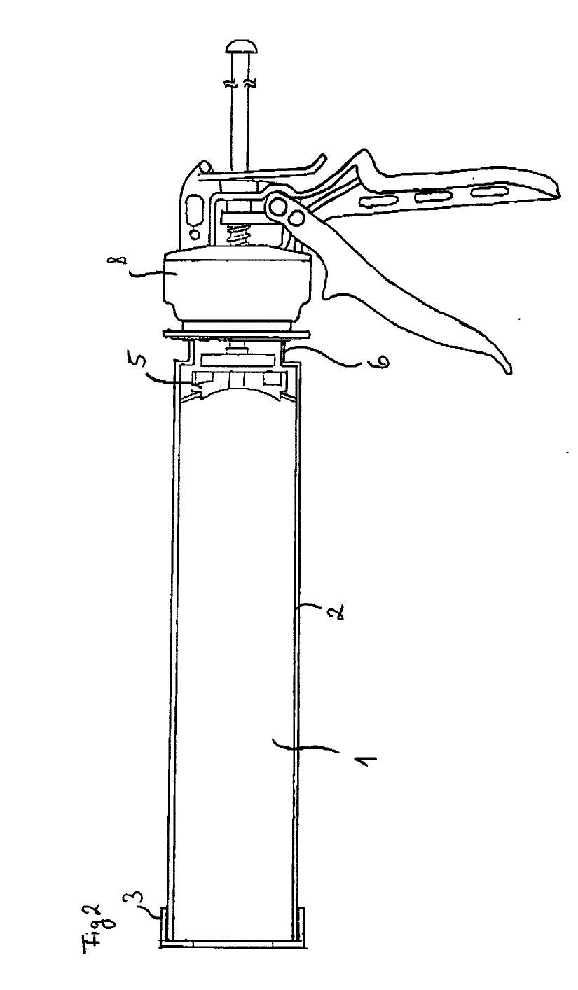

The cartridge 1 illustrated in FIG. 1 is in the form of an elongate hollow-cylindrical cartridge housing member 2, the one end of which is closed off by a lid 3. This lid 3 is screwed onto an external thread of the housing member 2. The lid 3 hag a central recess or hole into or through which an injection nozzle 4 is inserted. The opposite end of the cartridge housing 1 has a connecting piece 6 which trails the housing member 2. This connecting piece 6 is used to connect the cartridge housing 1 to a cartridge gun 8 (FIG. 2). The cartridge gun 8 has thereby a cartridge receiving structure into which the connecting piece 6 is inserted together with its associated cartridge 1. The cartridge gun 8 is thereby suited for both common cartridges and also cartridges 1 for receiving therein bags of injection-material.

To squeeze the injection material out of the bag 7, same must initially be inserted into the housing member 2 of the cartridge 1. The lid 3 is unscrewed from the housing member 2 for this purpose, the piston S is moved to the other end of the cartridge 1 and the bag 7 is inserted after having been cut open. The injection nozzle 4 is placed onto the open end of the bag 7, and the lid 3 is subsequently moved over the portion of the injection nozzle 4 projecting from the housing member 2 and is thence screwed to the housing member 2. When the piston 5 is now moved in direction of the injection nozzle 4, the injection material from the bag 7 is pressed through the injection nozzle 4 out of the cartridge 1.

The shape of such a cartridge is thereby independent of the cartridge gum a which is being used, since solely the connecting piece 6 is decisive as to whether or which cartridge gun a can be used, The housing member 2 can have any desired volume and any desired cross-sectional area. Thus also bags 7 of many different sizes and volume can be utilized with the cartridge 1 and the cartridge gun 8.

### LIST OF REFERENCE NUMERALS

1 cartridge

2 housing member

3 lid

4 spray nozzle

5 piston

6 connecting piece

7 bag

8 cartridge gun

What is claimed is:

1. A cartridge for a cartridge gun in which the cartridge can be connected self-supportingly to the cartridge gun, and for receiving a bag filled with an injection material, said cartridge comprising a housing member in which a piston is arranged longitudinally movably toward an end closed off by a lid, wherein the lid has an opening through which an injection nozzle is received, wherein the housing member hag on an end remote from the lid an area in form of an annular connecting piece for facilitating connection of the cartridge to a cartridge gun.

2. The cartridge according to claim 1, wherein the connecting piece has an outside diameter which is approximately the same as the diameter of a common cartridge.

3. The cartridge according to claim 1, wherein the connecting piece has an outside diameter which is the same or insignificantly smaller than the inside diameter of an annular receiving part of the cartridge gun.

4. The cartridge according to claim 1, wherein the connecting piece has an inside diameter which is the same or insignificantly larger than the outside diameter of a connecting surface of the cartridge gun onto which the cartridge can be mounted.

5. The cartridge according to claim 1 wherein the lid is a screw cap into Which the injection nozzle can be inserted.

6. The cartridge according to claim 5, wherein the screw cap is connected via a screw connection to the housing member.

7. The cartridge according to claim 1, wherein the lid is connected via a bayonet catch to the housing member.
